(19) United States
(12) Patent Application Publication
(10) Pub. No.: US 2016/0020661 A1
(43) Pub. Date: Jan. 21, 2016

(54) ELECTRICAL MACHINE ROTOR PROVIDED WITH AT LEAST ONE HOOP FOR RETENTION OF THE CHIGNONS OF THE WINDING, AND CORRESPONDING ELECTRICAL MACHINE

(71) Applicant: VALEO EQUIPEMENTS ELECTRIQUES MOTEUR, Creteil Cedex (FR)

(72) Inventors: Laurent ODIN, Chamagnieu (FR); Maximilien GENTIL, Corbas (FR)

(21) Appl. No.: 14/773,559

(22) PCT Filed: Mar. 12, 2014
(86) PCT No.: PCT/FR2014/050557

§ 371 Date: Sep. 8, 2015

(30) Foreign Application Priority Data
Mar. 14, 2013 (FR) 1352249

(51) Int. Cl. H02K 3/51; H02K 3/38

(52) U.S. Cl. CPC H02K 3/51; H02K 3/38

(57) ABSTRACT

A wound rotor comprising a cylindrical body mounted on a shaft, a collector including a set of electrically conductive blades, notches that are longitudinally provided on an outer periphery of the body of the rotor, and a winding made of a set of conductors that is at least partially inserted inside the notches and is electrically connected to the blades of the collector, portions of the conductors that project relative to the radial surfaces an axial end of the body of the rotor constituting the turns of the winding. The rotor further comprises at least one hoop provided around a turn having an axially oriented annular wall provided with means for retaining the hoop axially relative to the body of the rotor and rotatably relative to an axis of the hoop.

### FIELD OF THE INVENTION

The invention relates to a rotor which is provided with at least one hoop for retention of the chignons of the winding, as well as to the corresponding electrical machine. The invention has a particularly advantageous, but not exclusive, application in the field of motor vehicle starters.

### PRIOR ART

Electrical machines are known which are provided with a stator, or inductor, comprising a plurality of permanent magnets or wound poles (electromagnets) and a rotor, or armature, comprising conductors which form the winding of the rotor provided with a body with a cylindrical form. An air gap exists between the outer periphery of the rotor body and the inner periphery of the stator magnets.

As shown in FIG. 1, the rotor 1 comprises a collector 2 provided with electrically conductive blades 3, such as copper blades, which extend side by side on its outer periphery. The rotor 1 also has longitudinal notches 5 provided in its body 8, consisting of a set of plates. In order to form the winding, conductors 9, the ends of which are welded onto a part of each blade 3, are fitted inside the notches 5. In this known configuration of a drum type, the axis of the notches 5 coincides with the axis of the blades 3, i.e. the blades 3 are opposite the notches 5.

More specifically, each conductor 9, which is covered by a layer of enamel 91 for its insulation, has two branches which are connected by a base 93, such as to form a “U”. These conductors 9, the ends of which are welded onto the blades 3 of the collector 2, are fitted inside notches 5 in the rotor, on two distinct layers, i.e. the upper layer and the lower layer. The parts of the conductors 9 which extend projecting from each side of the rotor 1 are known as chignons 12, 13.

In order to ensure radial retention of the conductors 9 in the chignons, and thus avoid the effects of the centrifugal force, hoops 14, 15 are positioned respectively around the chignons 12, 13. In order for the hoops 14 to have good mechanical strength, substantial clamping is carried out between the hoops 14, 15 and the chignons 12, 13. Generally, the diameter of a chignon 12, 13 is between 46.7 and 47 mm, whereas the inner diameter of a hoop 14, 15 is between 46.45 and 46.55 mm. The clamping between the hoop 14, 15 and the corresponding chignon 12, 13 is between minus 0.15 mm and minus 0.55 mm.

The clamping of the hoop 14, 15 is such that there is not enough space between two adjacent conductors 9 to permit migration of a varnish 16 during an impregnation operation, as can be seen clearly from FIGS. 2a and 2b. During the use of the electrical machine, the vibrations can thus damage the layer of enamel 91 of the conductors 9, which generates problems of short-circuiting at the level of the adjacent conductors 9 in contact inside the chignons 12. 13.

### SUBJECT OF THE INVENTION

The object of the invention is to eliminate this disadvantage efficiently by proposing a wound rotor comprising:
a body with a cylindrical form fitted on a shaft;
a collector comprising a set of electrically conductive blades;
notches provided longitudinally in an outer periphery of the rotor body; and
a winding formed by a set of conductors which are fitted at least partly inside the notches, and are connected electrically to the blades of the collector, with parts of the conductors extending so as to project relative to radial axial end faces of the rotor body which constitute chignons of the winding,
   characterised in that it additionally comprises at least one hoop which is fitted axially relative to the body, around a chignon with an annular wall with axial orientation provided with means for retention of the hoop, in order to render the hoop axially integral with the chignon, and integral in rotation relative to an axis of the hoop.

Since the hoop is provided with retention means, it is possible to reduce the clamping force between the hoops and the chignons, or even to fit them with play. Consequently, the conductors which are subjected to less stress in the chignons are spaced from one another, which makes it possible to optimise the level of filling of varnish inside the chignons, and therefore to reduce greatly the risks of short-circuiting.

According to one embodiment, the means for retention of the hoop are designed to impose a form on an impregnation layer situated at the periphery of the chignon, such that the hoop is retained by the said layer of impregnation varnish.

Thus, a simple impregnation layer makes it possible to render the hoop integral with the conductors of the chignon.

According to one embodiment, the impregnation layer is a layer of impregnation varnish on all of the rotor, in order to strengthen the said rotor.

This makes it possible to use a single layer in order to strengthen both the segments of conductors in the chignons and the hoop on the chignon.

According to one embodiment the means for retention comprise at least one hole provided in the wall of the hoop for the passage of the impregnation layer, such that the layer of impregnation varnish has at least one projection which penetrates inside the hole.

According to one embodiment, the hole is a through opening.

This allows the impregnation layer to infiltrate between the portions of the segments of conductors, surrounded by the hoop, and delimited by the radial plane of the hoop.

According to one embodiment, the opening has an axis which is oriented radially relative to the axis of the hoop.

This makes it possible to improve the infiltration of the infiltration layer in the opening in the hoop.

According to one embodiment, the means for retention comprise a plurality of openings which are spaced angularly regularly around the wall of the hoop.

This makes it possible to render the hoop integral homogenously on the chignons.

According to one embodiment, the means for retention comprise at least one protuberance which is designed to penetrate inside at least one hollow in the layer of impregnation varnish.

In an example of this embodiment, the protuberance is either axial, and the impregnation layer prevents the rotation of the hoop by means of this protuberance. This makes it possible to ensure the anti-rotation of the hoop relative to the chignon, even in the case of a substantial centrifugal force.

According to another embodiment previously described, the impregnation layer which is placed on the chignon in order to strengthen the segments of conductor of the chignon is put into place before the insertion of the hoop.

In this embodiment, the portions of the segments of conductor which are situated radially under the hoop are in contact by means of the impregnation layer. This makes it possible to prevent vibration from causing the varnish between the portions of segments of the conductors opposite to be removed by sintering, and therefore to prevent electrical contact which gives rise to malfunctioning of the rotor.

According to one embodiment, the hoop and the chignon are fitted together with play of between plus 0.15 mm and minus 0.14 mm.

This positive and negative play makes it possible to insert the hoop manually around segments of conductors which form the chignons, whilst ensuring by means of the impregnation layer its role of retention of the segments of conductors of the chignon against the centrifugal force.

According to one embodiment, the hoop has an inner diameter of between 47.55 mm and 47.65 mm, whereas the chignon has an outer diameter of between 47.5 mm and 47.8 mm.

According to one embodiment, the hoop is made of an electrically insulating material.

This makes it possible to prevent a short-circuit between conductors by means of the hoop in the case when two portions of segments of conductors are without an insulator during friction between the hoop and these portions of conductors.

According to one embodiment, the rotor comprises two hoops which are each positioned around a chignon.

This makes it possible to ensure the retention of the two chignons for a certain type of winding.

According to one embodiment, two portions of the conductors surrounded by the hoop, and delimited by the radial plane of the hoop, are in contact by means of an impregnation layer. This makes it possible to prevent the insulators of the portions of conductors from being worn away by the vibrations.

The subject of the invention is also an electrical machine, characterised in that it comprises a rotor according to the invention.

### BRIEF DESCRIPTION OF THE DRAWINGS

The invention will be better understood by reading the following description and examining the accompanying figures. These figures are provided purely by way of illustration of the invention, but in no way limit it.

FIG. 1, already described, shows an overview in perspective of a rotor according to the prior art.

FIGS. 2a and 2b, already described, shows views in cross-section of the conductors in the chignons, respectively after the positioning of a retention hoop around the chignon, and after the operation of impregnation for a rotor according to the prior art.

FIG. 3 shows an overview in perspective of a rotor according to the invention.

FIGS. 4a and 4b represent respectively views in perspective and in transverse cross-section of a hoop for retention of a chignon according to the invention.

FIG. 4c represents a view in cross-section of the retention hoop according to the plane B-B in FIG. 4b, perpendicular to an axis of the hoop.

FIGS. 5a and 5b show views in cross-section of the conductors in the chignons respectively after positioning of a retention hoop around the chignon, and after the impregnation operation for a rotor according to the invention.

FIGS. 6a and 6b show schematic representations of the area of connection between the retention hoop according to the invention and the layer of impregnation varnish according to two embodiments of the invention.

FIG. 7 shows a schematic representation of the two layers of conductors positioned inside notches in the rotor, showing the notch insulator in the form of an “S”.

Elements which are identical, similar or analogous retain the same references from one figure to another.

### DESCRIPTION OF EMBODIMENTS OF THE INVENTION

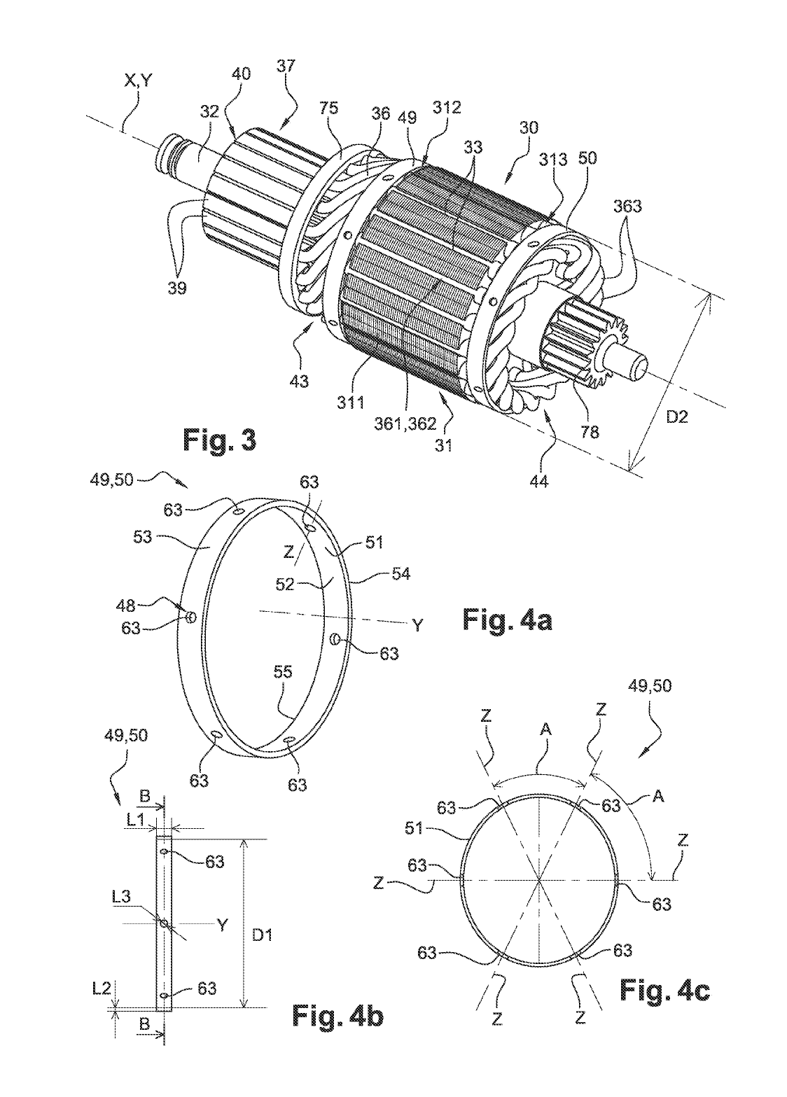

FIG. 3 shows a rotor 30 comprising a body 31 fitted on a shaft 32 with an axis X. This body 31 in the form of a set of plates has an outer periphery 311 with a cylindrical form which is delimited axially by two end faces 312, 313 with radial orientation. Notches 33 are provided longitudinally in the outer periphery of the body 31. In order to form the winding, a set of conductors 36 is fitted inside each of these notches 33.

In addition, the rotor 30 is provided with a collector 37 comprising a plurality of contact parts, in this case electrically conductive blades 39 on which the ends of the conductors 36 are welded. According to one embodiment, the blades 39 as well as the conductors 36 are made of copper. The blades 39 of the collector 37 are supported by a support 40 made of plastic material which is integral with the shaft 32. For good temperature resistance, the support 40 of the collector is made of thermosetting plastic material, such as a phenolic thermosetting plastic material, for example Bakelite. In this case, the collector 37, which has blades 39 extending longitudinally side by side on the outer periphery of the support 40, is of the “drum” type. However, as a variant, the collector 37 used can be a collector of the flat type.

More specifically, each conductor 36 is in this case covered with an electrically insulating layer 360 such as enamel, and has two branches 361, 362 which are connected by a base 363, such as to form a “U”. The ends of a conductor 36 welded on the blades 39 are constituted by the free ends of each branch 361, 362. As can be seen in FIG. 7, the conductors 36 are fitted inside notches 33 in two distinct layers, i.e. the upper layer and the lower layer. If one of the branches 361, 362 is positioned in the lower layer, then the other branch 361, 362 is situated in the upper layer, and conversely. The transverse cross-section of the conductors 36 can be round, or square, or rectangular. The parts of the conductors 36 which extend projecting relative to the end faces 312, 313 of the body 31 of the rotor 30 form the chignons 43, 44 of the winding.

As shown in FIG. 7, a notch insulator 46 is positioned around branches 361, 362 of the conductors. In this case, this insulator 46 has a cross-section in the form of an “S”. This insulator makes it possible not to damage the conductors 36 (covered with the thin layer of enamel 360) when they are fitted in the set of plates of the rotor 30, which by definition has flash, and is grooved for force-fitting of the set of plates of the rotor. This also insulates the conductors 36 electrically against the set of plates which is connected to the earth via the housing of the starter. In addition, the play between the insulator 46 and the edges of the notches 33 is filled by an impregnation varnish.

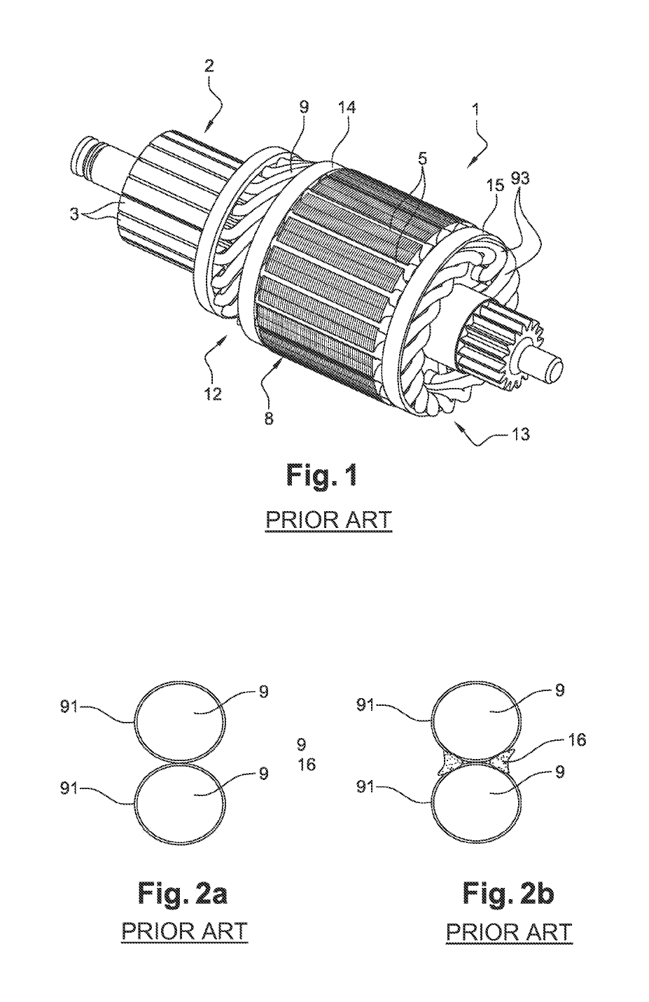

Hoops 49, 50 made of electrically insulating material, shown in FIG. 1, are fitted around chignons 43, 44. Thus, a first hoop 49 is fitted around the chignon 43 which is situated on the collector 37 side, and is formed in particular by the ends of the branches of the conductors 36. A second hoop 50 is fitted around the chignon 44 which is situated on the opposite side, and is formed in particular by the bases 363 and a part of the branches 361, 362 of the conductors 36 situated in the vicinity of the bases 363.

These hoops 49, 50, which are shown in detail in FIGS. 4a to 4c, retain the conductors 36 radially, in order to prevent the effects of the centrifugal force from being exerted on the chignons 43, 44. Each hoop 49, 50 is provided with means 48 for retention of the hoop axially relative to the body 31, and in rotation relative to an axis Y of the hoop 49, 50. This axis Y is substantially combined with the axis X of the rotor, when the hoop 48, 49 is positioned around the chignon 43, 44 of the corresponding winding.

More specifically, these hoops 49, 50 have an annular wall 51 with axial orientation, with an inner periphery 52 which is designed to be placed against an outer periphery of the corresponding chignon 43, 44, and an outer periphery 53 which faces towards the exterior of the hoop. The inner periphery 52 and the outer periphery 53 are connected by edges 54, 55 of axial ends. One of the edges 54 is designed to be positioned in the vicinity of an end face 312, 313 of the rotor 30, whereas the other edge 55 is designed to be positioned axially on the opposite side.

In the embodiment in FIGS. 4a to 4c and FIG. 6a, the retention means 48 comprise through openings 63 for the passage of the impregnation varnish, which are provided in the wall 51. These openings 63 have an axis Z with orientation which is radial relative to the axis Y of the wall of the hoop 49, 50.

Thus, as can be seen clearly in FIG. 6a, the impregnation varnish can penetrate inside openings 63 which act as a mould in order to form projections 64 in the layer of varnish 68 which is situated at the level of the outer periphery of the chignon 43, 44. These projections 64 have a form which is complementary to the openings 63. Thus, the hoops 49, 50 are retained axially and in rotation by the projections 64 engaged with the openings 63. For this purpose, a varnish is used which is for example based on epoxy resin which is applicable hot, and stiffens during its polymerisation. In other words, the openings 63 which are provided in the wall 51 of the hoops 49, 50 act as an axial lock, and block in rotation the hoops 49, 50, which are retained by the polymerised impregnation varnish penetrating inside the openings 63.

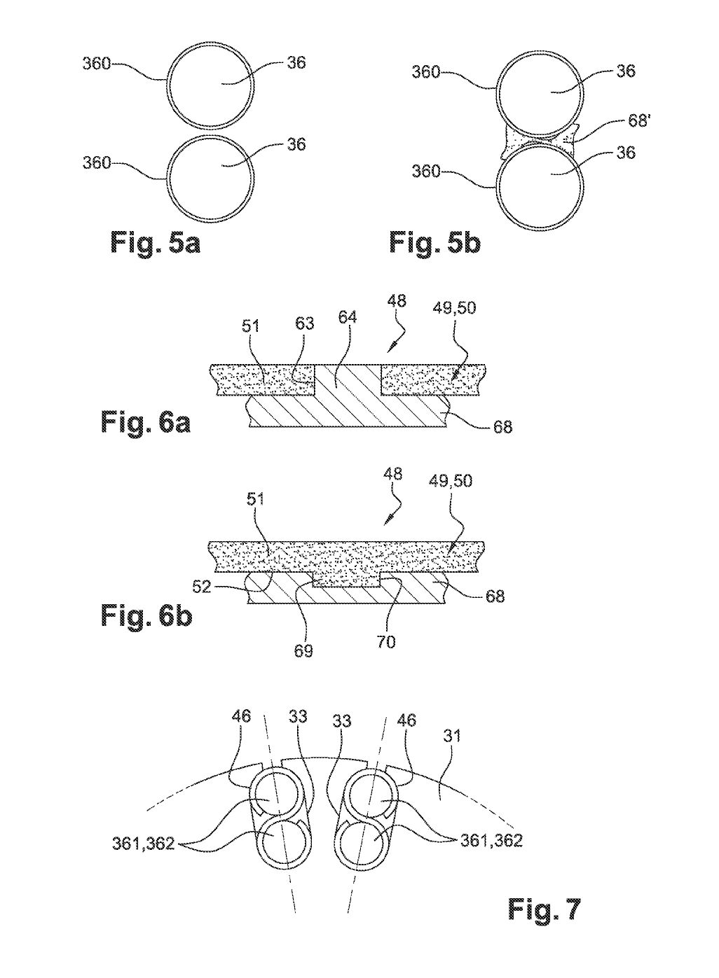

A mechanical connection of this type between the hoop 49, 50 and the layer of varnish makes it possible to fit each hoop 49, 50 around the corresponding chignon 43, 44, either with positive play or with negative play, corresponding to lesser clamping than in the existing systems, such that a slight space exists between the adjacent conductors 36 of the chignons, as can be seen clearly in FIG. 5a. This makes it possible to ensure migration of the impregnation varnish 68′ inside the chignons 43, 44, and thus good insulation between the conductors 36, as shown in FIG. 5b.

In this case, each hoop 49, 50 comprises six openings 63, which are spaced angularly regularly around the wall 51 of the hoop 49, 50. An angular distance A of approximately 60° therefore exists between two consecutive openings 63 (cf. FIG. 4c). It will be appreciated that the number of openings 63 can vary according to the application. As a variant, the openings 63 are not through openings. As a variant, the openings 63 have an axis Z with orientation which is axial relative to the axis Y of the wall 51, and have for example the form of elongate openings with a rectangular form which extend between the edges 54, 55 of the annular wall 51 of the hoops.

Preferably, the hoops 49, 50 and the chignons 43, 44 are fitted together with play which is preferably between plus 0.15 mm and minus 0.14 mm. Positive play means that the hoop 49, 50 has an inner diameter D1 which is larger than the outer diameter D2 of the corresponding chignon 43, 44 (the chignons 43 and 44 can have different outer diameters D2), whereas negative play means that the hoop 49, 50 has an inner diameter D1 which is smaller than the outer diameter D2 of the corresponding chignon 43, 44. However, in certain applications, it is possible to increase the clamping as far as negative play levels of approximately minus 0.25 mm.

Preferably, the hoop 49, 50 has an inner diameter D1 of between 47.55 mm and 47.65 mm, whereas the chignon has an outer diameter D2 (cf. FIG. 1) of between 47.5 mm and 47.8 mm.

In the particular embodiment shown in FIG. 4b, each hoop 49, 50 has an inner diameter D1 of approximately 47.6 mm, a length L1 of approximately 5 mm, and a thickness L2 of approximately 1 mm. The openings 63 have a diameter L3 of approximately 2.5 mm.

According to another embodiment shown in FIG. 6b, the retention means 48 comprise protuberances 69 which replace or complement the openings 63. These protuberances 69 are for example in the form of a cylindrical rod with small dimensions, obtained from the inner periphery 52 of the wall of the hoop 49, 50, and facing towards the inside of the hoop 49, 50. Thus, during the impregnation phase, the hoops 49, 50 will impose on the layer of varnish 68 a form such that the protuberances 69 will penetrate inside hollows 70 in the layer of varnish 68. Thus, the hoops 49, 50 will be retained axially and in rotation relative to the axis Y by the said protuberances 69 engaged with the hollows 70, after polymerisation of the layer of varnish 68.

Preferably, the hoops 49, 50 are made of an electrically insulating material. In addition, the hoops 49, 50 are advantageously made in a single piece, i.e. there is continuity of material between the different areas of a hoop 49, 50.

In addition, as can be seen in FIG. 1, a third hoop 75 ensures radial retention of the conductors 36, in order to prevent the effects of the centrifugal force from being exerted on the welds of the ends of the conductors 36 between one another, and on the blades 39 of the collector 37.

At an end of its shaft 32, the rotor 30 can comprise a gear wheel 78 which is situated on the side opposite the collector 37, and is designed to form a planet wheel in a planetary gear train speed reduction system of a starter, as described for example in document FR2787833.

The subject of the invention is also the electrical machine equipped with the rotor 30 previously described.

1. Wound rotor (30), comprising:
a body (31) with a cylindrical form fitted on a shaft (32);
a collector (37) comprising a set of electrically conductive blades (39);
notches (33) provided longitudinally in an outer periphery of the rotor body (31); and
a winding formed by a set of conductors (36) which are fitted at least partly inside the notches (33), and are connected electrically to the blades (39) of the collector (37), with parts of the conductors (36) extending so as to project relative to radial axial end faces of the rotor body which constitute chignons (43, 44) of the winding,
wherein it additionally comprises at least one hoop (49, 50) which is fitted axially relative to the body (31), around a chignon (43, 44) with an annular wall (51) provided with means (48) for retention of the hoop, in order to render the hoop axially integral with the chignon, and integral in rotation relative to an axis (Y) of the hoop (49, 50).

2. Rotor according to claim 1, characterised in that the means (48) for retention of the hoop (49, 50) are designed to impose a form on an impregnation layer (68) situated at the periphery of the chignon (43, 44), such that the hoop (49, 50) is retained by said impregnation layer (68).

3. Rotor according to claim 2, wherein the impregnation layer is a layer of impregnation varnish on all of the rotor, in order to strengthen said rotor.

4. Rotor according to claim 2, characterised in that the means (48) for retention comprise at least one hole (63) provided in the wall (51) of the hoop (49, 50) for the passage of the impregnation layer, such that the impregnation layer (68) has at least one projection (64) which penetrates inside the hole (63).

5. Rotor according to claim 4, characterised in that the hole is a through opening (63).

6. Rotor according to claim 5, characterised in that the hole (63) has an axis (Z) which is oriented radially relative to the axis (Y) of the hoop (49, 50).

7. Rotor according to claim 4, characterised in that the means for retention comprise a plurality of openings (63) which are spaced angularly regularly around the wall (51) of the hoop.

8. Rotor according to claim 2, characterised in that the means (48) for retention comprise at least one protuberance (69) which is designed to penetrate inside at least one hollow (70) in the layer of impregnation varnish (68).

9. Rotor according to claim 1, characterised in that the hoop (49, 50) and the chignon (43, 44) are fitted together with play of between plus 0.15 mm and minus 0.14 mm.

10. Rotor according to claim 1, characterised in that the hoop (49, 50) has an inner diameter (D1) of between 47.55 mm and 47.65 mm, whereas the chignon (43, 44) has an outer diameter (D2) of between 47.5 mm and 47.8 mm.

11. Rotor according to claim 1, characterised in that the hoop (49, 50) is made of an electrically insulating material.

12. Rotor according to claim 1, characterised in that it comprises two hoops (49, 50) which are each positioned around a chignon.

13. Rotor according to claim 1, wherein two portions of the conductors surrounded by the hoop, and delimited by the radial plane of the hoop, are in contact by means of an impregnation layer.

14. Electrical machine, characterised in that it comprises a rotor (30) according to claim 1.

15. Rotor according to claim 3, characterised in that the means (48) for retention comprise at least one hole (63) provided in the wall (51) of the hoop (49, 50) for the passage of the impregnation layer, such that the impregnation layer (68) has at least one projection (64) which penetrates inside the hole (63).

16. Rotor according to claim 4, characterised in that the hole (63) has an axis (Z) which is oriented radially relative to the axis (Y) of the hoop (49, 50).

17. Rotor according to claim 5, characterised in that the means for retention comprise a plurality of openings (63) which are spaced angularly regularly around the wall (51) of the hoop.

18. Rotor according to claim 6, characterised in that the means for retention comprise a plurality of openings (63) which are spaced angularly regularly around the wall (51) of the hoop.
